(19) United States
(12) Patent Application Publication
(10) Pub. No.: US 2026/0266439 A1
(43) Pub. Date: Sep. 10, 2026

(54) Multi-Function Tabletop Stand

(71) Applicant: Rapid Conn, Irvine, CA (US)

(72) Inventor: Balaji Raghunathan, Irvine, CA (US)

(73) Assignee: Rapid Conn, Irvine, CA (US)

(21) Appl. No.: 19/070,024

(22) Filed: Mar. 4, 2025

(51) Int. Cl. F21S 6/00; A45D 42/10; A45D 42/16; F21V 21/26; F21V 21/30; F21V 33/00; H04R 1/02; H04R 1/10

(52) U.S. Cl. CPC F21S 6/003; A45D 42/10; A45D 42/16; F21V 21/26; F21V 21/30; F21V 33/004; H04R 1/026; H04R 1/028; H04R 1/1025; H04R 2420/07; H04R 2420/09

(57) ABSTRACT

A multi-function tabletop stand includes a stand base, a plurality of electrical interfaces, an illumination device, a charger, a speaker for audio, and a power supply for power. The stand base includes a plurality of receptacles. Each of the plurality of electrical interfaces is positioned in a respective one of the receptacles. The illumination device includes a coupler portion positioned in a respective one of the receptacles and coupled to a respective one of the electrical interfaces. The illumination device is positioned to extend from the stand base. The charger is positioned in a respective one of the receptacles and coupled to a respective one of the electrical interfaces. The charger includes a rechargeable battery. The charger is designed to charge a personal electronic device. The speaker is positioned in a respective one of the receptacles and coupled to a respective one of the electrical interfaces.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to desktop or tabletop devices and appliances and more particularly pertains to a new multi-function tabletop stand that is an all-in-one device for providing light, audio, and electricity for charging personal electronic devices, including smartphones, smart watches, and wireless earphones. The new multi-function tabletop stand provides a compact and modular overall design that saves space but allows for multiple and varied uses as described further herein.

### (2) Description of Related Art Including Information Disclosed Under 37 CFR 1.97 and 1.98

The prior art relates to desktop or tabletop devices and appliances. The prior art, as best understood, does not disclose a multi-function tabletop stand that includes a stand base, a plurality of electrical interfaces, an illumination device, a charger, a speaker, and a power supply, wherein the stand base includes a plurality of receptacles each designed to receive a respective one of the illumination device, the charger, and the speaker. Each of the plurality of electrical interfaces is positioned in a respective one of the receptacles to connect to the illumination device, the charger, and the speaker.

### BRIEF SUMMARY OF THE INVENTION

An embodiment of the disclosure meets the needs presented above in a multi-function tabletop stand generally comprising a stand base, a plurality of electrical interfaces, an illumination device, a charger, a speaker, and a power supply. The stand base includes a plurality of receptacles. Each of the plurality of electrical interfaces is positioned in a respective one of the receptacles. The illumination device includes a coupler portion positioned in a respective one of the receptacles and coupled to a respective one of the electrical interfaces. The illumination device is positioned to extend from the stand base. The charger is positioned in a respective one of the receptacles and coupled to a respective one of the electrical interfaces. The charger includes a rechargeable battery. The charger is designed to charge a personal electronic device. The speaker is positioned in a respective one of the receptacles and coupled to a respective one of the electrical interfaces. The speaker is designed to emit audio. The power supply is designed to supply power to the electrical interfaces.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of a multi-function tabletop stand according to an embodiment of the disclosure.

FIG. 2 is an exploded view of an embodiment of the disclosure.

FIG. 3 is a top view of a stand base of an embodiment of the disclosure.

FIG. 4 is a front view of the stand base embodiment of the disclosure in FIG. 3.

FIG. 5 is a top perspective view of a speaker of an embodiment of the disclosure.

FIG. 6 is a bottom perspective view of the speaker of an embodiment of the disclosure in FIG. 5.

FIG. 7 is a bottom perspective view of a charger of an embodiment of the disclosure.

FIG. 8 is a top perspective view of the charger of an embodiment of the disclosure in FIG. 7.

FIG. 9 is a bottom perspective view of a lamp of an embodiment of the disclosure.

FIG. 10 is a perspective view of an embodiment of the disclosure in use.

FIG. 11 is a side view of an embodiment of the disclosure in use.

FIG. 12 is a top front perspective view of a multi-function tabletop stand according to an alternative embodiment of the disclosure.

FIG. 13 is a top front perspective view of a makeup mirror according to the alternative embodiment of the disclosure in FIG. 12.

### DETAILED DESCRIPTION OF THE INVENTION

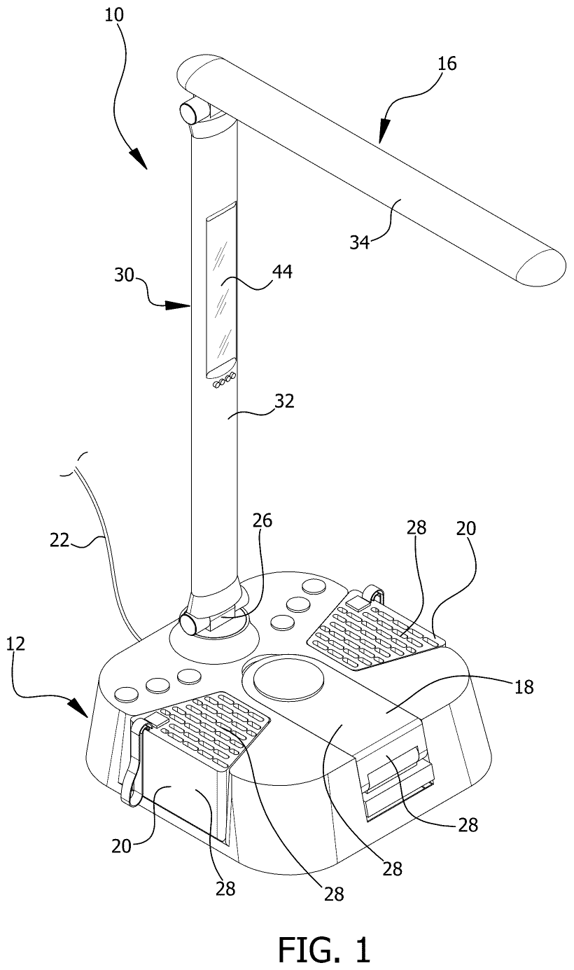

With reference now to the drawings, and in particular to FIGS. 1 through 13 thereof, a new multi-function tabletop stand embodying the principles and concepts of an embodiment of the disclosure and generally designated by the reference numeral 10 will be described.

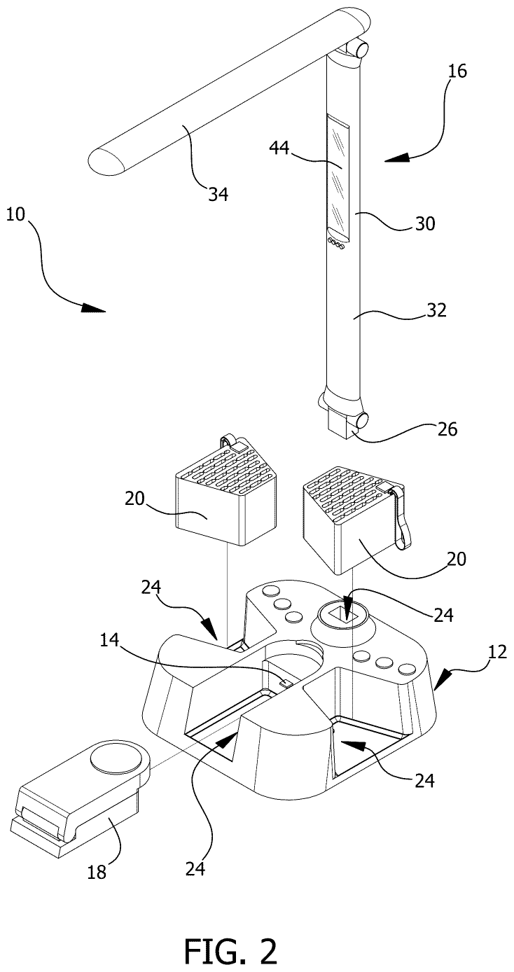

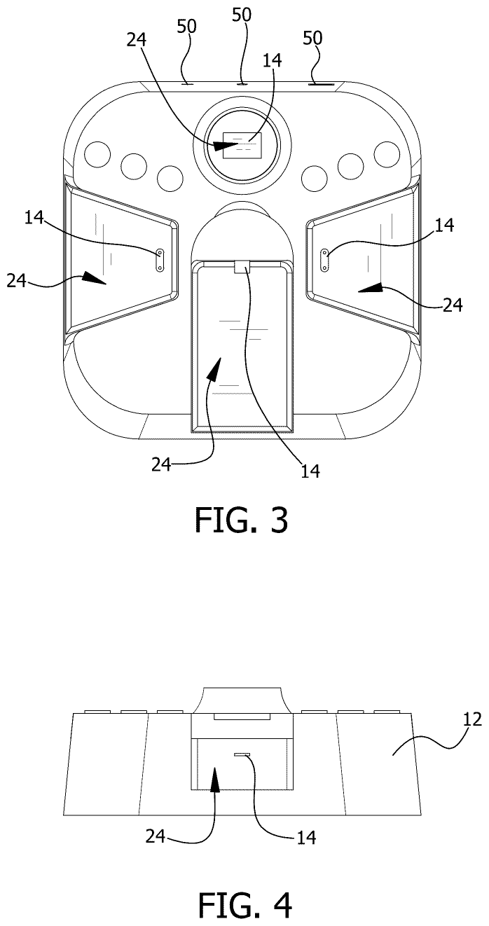

As best illustrated in FIGS. 1 through 13, the multi-function tabletop stand 10 generally comprises a stand base 12, a plurality of electrical interfaces 14, an illumination device 16, a charger 18, a speaker 20, and a power supply 22. As best seen in FIG. 2, the stand base 12 includes a plurality of receptacles 24. As best seen in FIG. 3, each of the plurality of electrical interfaces 14 is positioned in a respective one of the receptacles 24. With reference to FIGS. 1 and 2, the illumination device 16 includes a coupler portion 26 positioned in a respective one of the receptacles 24 and coupled to a respective one of the electrical interfaces 14. The illumination device 16 is positioned to extend from the stand base 12. The charger 18 is positioned in a respective one of the receptacles 24 and coupled to a respective one of the electrical interfaces 14. The charger 18 includes a rechargeable battery (not shown). The charger 18 is designed to charge a personal electronic device 60. The speaker 20 is positioned in a respective one of the receptacles 24 and coupled to a respective one of the electrical interfaces 14. The speaker 20 is designed to emit audio. The power supply 22 is designed to supply power to the electrical interfaces 14.

In the exemplary embodiment in FIG. 1, each of the receptacles 24 designed to receive the charger 18 and the speaker 20 is shaped to partially surround and follow an outer surface of its respective one of the charger 18 and the speaker 20. Each of the charger 18 and the speaker 20 is shaped such that exposed sections 28 of an outer surface thereof are aligned with adjacent sections of an outer surface of the stand base 12 to present a continuous surface appearance. To further explain, in the exemplary embodiment in FIGS. 1 and 2, the speaker 20 has a trapezoidal design. The respective receptacle also has a trapezoidal design shaped to match its speaker 20. Consequently, when the speaker 20 is inserted into the receptacle, as shown in FIG. 1, the exposed sections 28 of the outer surface of the speaker 20 follow or match the adjacent sections of the outer surface of the stand, thereby forming a continuous surface appearance that is compact and aesthetically pleasing. However, in another possible embodiment, one or more of the outer surfaces do not match or align. In addition, the speaker 20 can be a different shape, and the receptacle 24 would likewise be shaped accordingly. The electrical interfaces 14 can be of any known design. In the exemplary embodiment, the electrical interfaces 14 includes a USB prong for the charger 18, an electrical contact plate for the illumination device 16, and electrical contact nubs for the speakers 20. However, other designs, such as pins and plugs, are within the scope of the disclosure and can be used for any of the electrical interfaces 14. Each of the charger 18 and the speakers 20 also include their own form of the coupler portion 26, which can be a USB receptacle or recess for electrical contacts, though this is only one exemplary embodiment and other electrical connections can be used as are well known in the electronic arts.

The illumination device 16 is detachably coupled to the stand base 12. This modular design allows removal of the illumination device 16 for storage and transport. In another possible embodiment, this modular design allows for interchangeability of different types of illumination devices 16, such as different types of lamps, spotlights, makeup mirror 46s, and decorative lighting.

In the exemplary embodiment in FIGS. 1 through 11, the illumination device 16 is a lamp 30. The lamp 30 includes a lamp arm 32 extending vertically from the stand base 12. The lamp 30 includes a light 34 coupled to the lamp arm 32. In the exemplary embodiment, the light 34 is pivotably connected to the lamp arm 32. In addition, the lamp arm 32 is pivotably connected to the stand base 12. It should be noted that the lamp 30 shown in FIGS. 1 through 11 is only one exemplary embodiment, and other lamp designs well known in the lighting arts could be used and are within the scope of the disclosure.

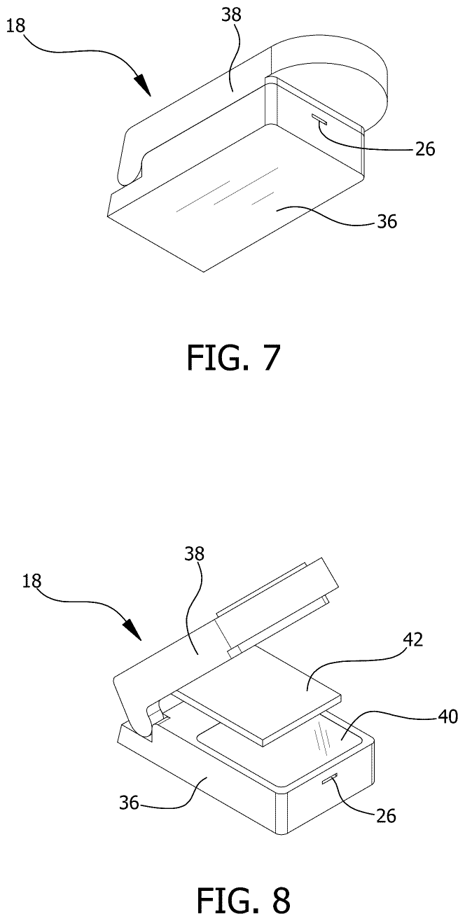

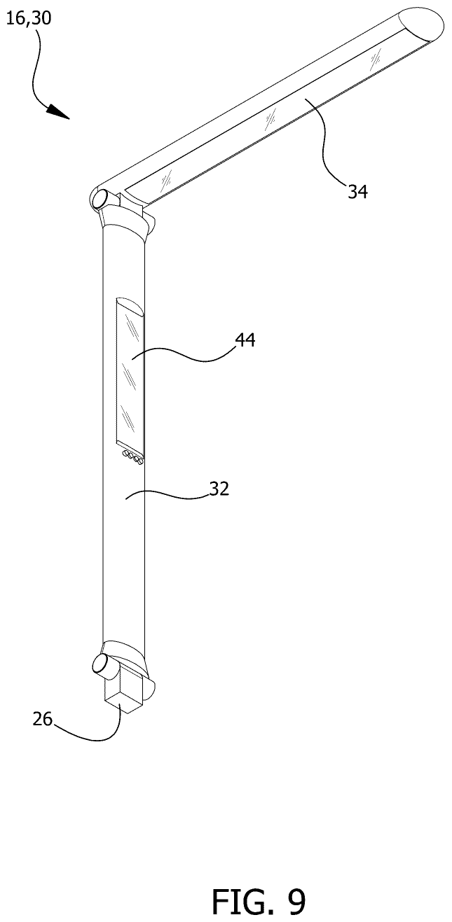

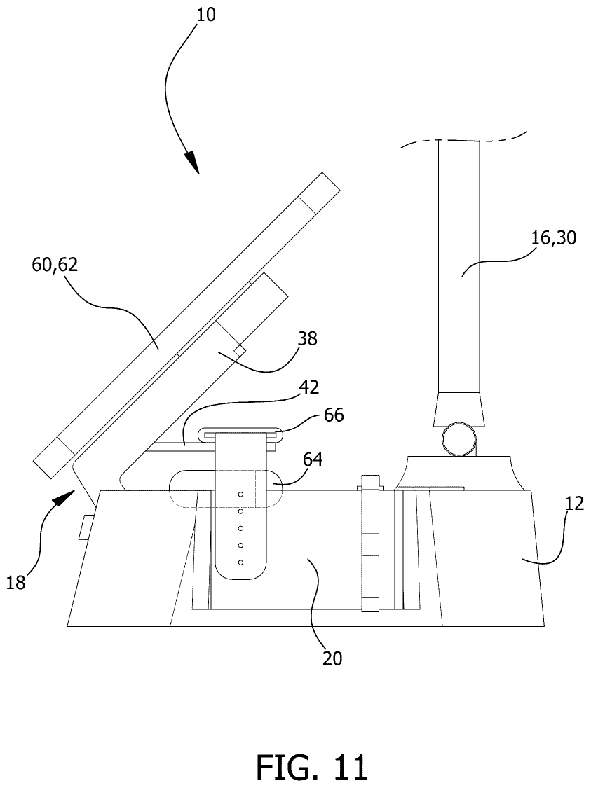

As shown in FIG. 2, the charger 18 is detachably coupled to the stand base 12, such that the charger 18 can be used in the stand base 12 or separate from the stand base 12. As shown in FIGS. 7 and 8, the charger 18 includes a charger base 36 and a charger panel 38 pivotably connected to the charger base 36 to selectively position the charger panel 38 at an angle with respect to the charger base 36. As shown in FIG. 11, the charger panel 38 is designed to support and charge a smartphone 62. For example, the charger panel 38 could include a magnet or a bracket to hold a smartphone 62 in place on the charger panel 38. As is well known in the electrical device arts, a wireless charging interface could be positioned in the charger panel 38 to charge smartphones placed thereon.

The charger base 36 includes a charger recess 40 designed to receive and charge wireless earphones. As shown in FIGS. 8 and 11, the charger recess 40 is designed to support a case 64 for wireless earphones or earbuds. Like the charger panel 38, a wireless charging interface could be positioned in the charger recess 40 to charge earphones placed thereon.

As shown in FIG. 8, the charger 18 includes a charger shelf 42 projecting from the charger panel 38 above the charger base 36 when the charger panel 38 is positioned at an angle with respect to the charger base 36. As shown in FIG. 11, the charger shelf 42 is designed to support and charge a smart watch 66 positioned thereon. Like the charger panel 38, a wireless charging interface could be positioned in the charger shelf 42 to charge a smart watch 66 placed thereon.

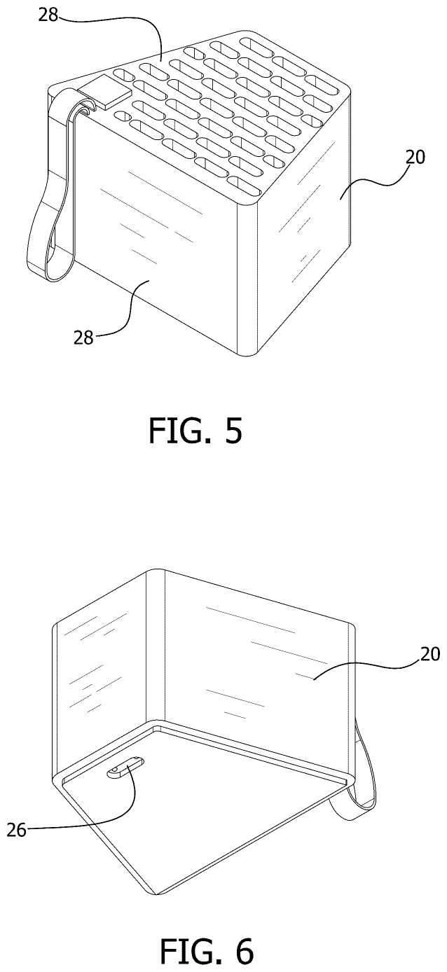

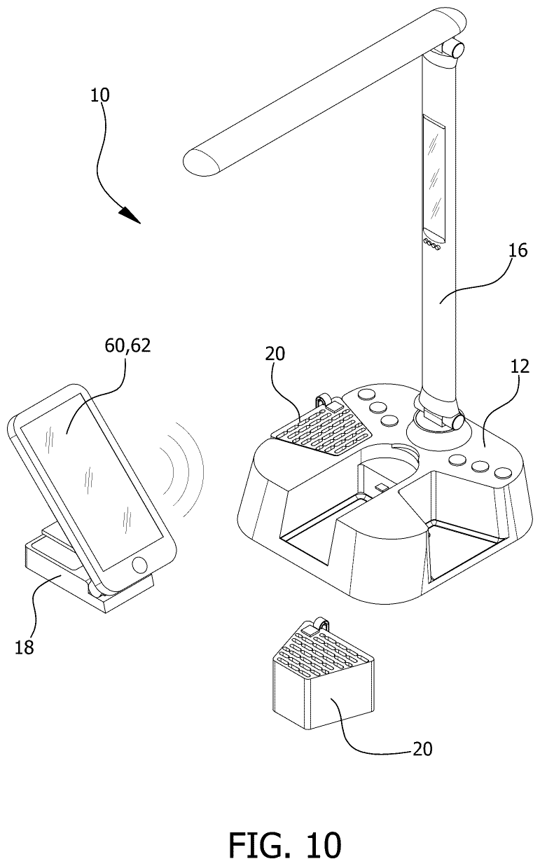

FIGS. 5 and 6 show an exemplary embodiment of the speaker 20. While in one possible embodiment the multi-function tabletop stand 10 includes only one speaker 20, the exemplary embodiment in the figures has two speakers 20, each positioned in a respective one of the receptacles 24. As shown in FIGS. 2 and 10, the speakers 20 are detachably coupled to the stand base 12. Each of the speakers 20 includes a rechargeable battery and is wirelessly connectable to an audio device. For example, the speakers 20 could be Bluetooth® speakers 20 that can be paired to an audio device, such as the personal electronic device 60 like the smartphone 62. In another possible embodiment, the multi-function tabletop stand 10 could include a microprocessor and memory to store audio files, such as music and alarm sounds, which could be played through the speakers 20.

In the exemplary embodiment in FIG. 1, the multi-function tabletop stand 10 further includes an electronic display 44 designed to display words and images. The electronic display 44 is positioned on the lamp arm 32, though in another possible embodiment the electronic display 44 could be placed elsewhere in the multi-function tabletop stand 10. As shown in FIG. 10, the electronic display 44 could be a liquid crystal display (LCD) that shows information such as the time, the date, and outside temperature, which can be controlled by the microprocessor, as is well known in the electronic arts.

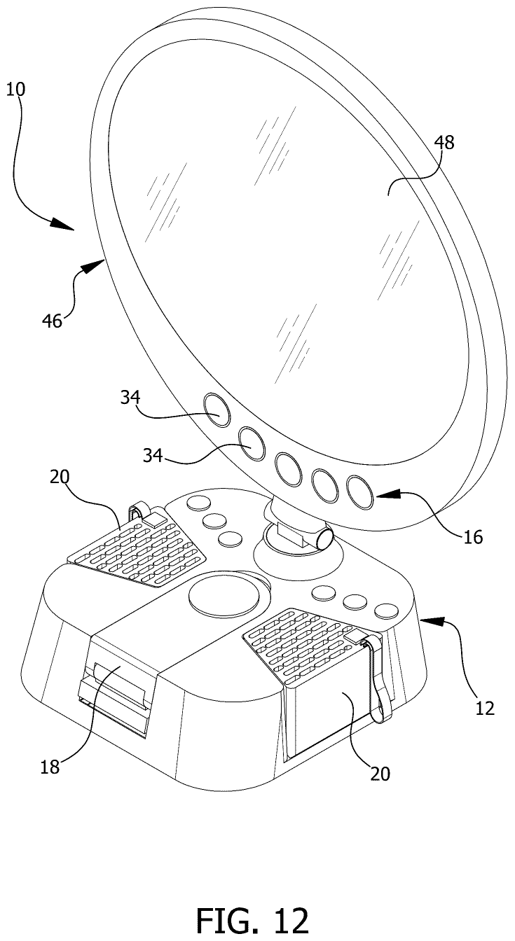

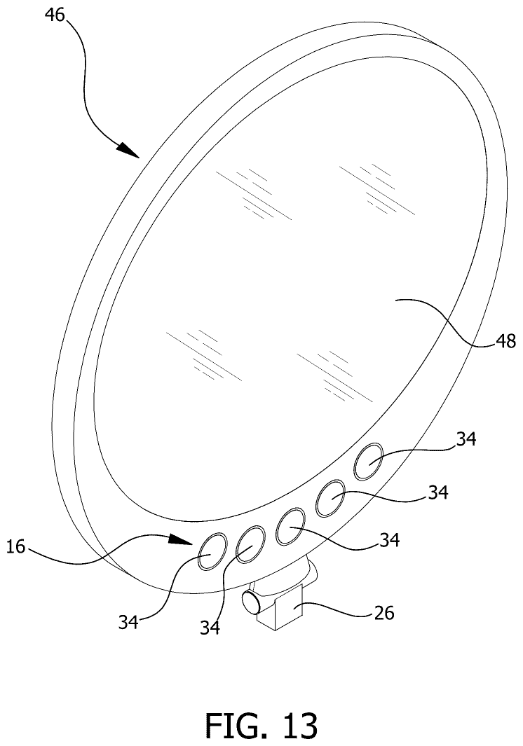

FIGS. 12 and 13 shows an alternative embodiment of the multi-function tabletop stand 10, wherein the illumination device 16 is a makeup mirror 46 instead of a lamp 30. The makeup mirror 46 includes a mirror portion 48 and at least one light 34 mounted at a perimeter of the mirror portion 48.

The multi-function tabletop stand 10 is used to provide a compact and aesthetically pleasing device for performing a variety of functions. The first use is to provide illumination via the lamp 30 or makeup mirror 46. The stand base 12 provides storage for the speakers 20 and the charger 18, as well as a recharging station for the speakers 20 and the charger 18. Instead of having multiple devices and holders scattered across a room or a desk, all devices are conveniently stored and charged in one area. The multi-function tabletop stand 10 includes control buttons for operating and programming the multi-function tabletop stand 10 to perform such tasks as powering the illumination device 16 on and off, programming the electronic display 44, and operating the speakers 20, as well as other tasks well known in the electronic arts.

As shown in FIG. 1, the power supply 22 can be a power cord or similar, such as a USB cable. The stand base 12 can include different ports 50, such as a USB port or other type of port for connecting to electronic devices or power supplies, as is well known in the electronic arts.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A multi-function tabletop stand comprising:
a stand base, said stand base including a plurality of receptacles, each of said receptacles being inset into an outer surface of said stand base;
a plurality of electrical interfaces, each of said plurality of electrical interfaces being positioned in a respective one of said receptacles;
an illumination device, said illumination device including a coupler portion being positioned in a respective one of said receptacles and coupled to a respective one of said electrical interfaces, said illumination device being positioned to extend from said stand base;
a charger, said charger being removably positionable in a respective one of said receptacles such that said charger occupies said respective one of said receptacles while remaining exposed on said stand base and is coupled to a respective one of said electrical interfaces, said charger including a rechargeable battery, said charger being configured to charge a personal electronic device;
a speaker, said speaker being removably positionable in a respective one of said receptacles such that said speaker occupies said respective one of said receptacles while remaining exposed on said stand base and is coupled to a respective one of said electrical interfaces, said speaker being configured to emit audio; and
a power supply, said power supply being configured to supply power to said electrical interfaces.

2. The multi-function tabletop stand of claim 1, wherein:
each of said receptacles configured to receive said charger and said speaker is shaped to partially surround and follow an outer surface of its respective one of said charger and said speaker; and
each of said charger and said speaker is shaped such that exposed sections of an outer surface thereof are aligned with adjacent sections of an outer surface of said stand base to present a continuous surface appearance.

3. The multi-function tabletop stand of claim 1, wherein said illumination device is detachably coupled to said stand base.

4. The multi-function tabletop stand of claim 1, wherein:
said illumination device is a lamp;
said lamp includes a lamp arm extending vertically from said stand base; and
said lamp includes a light coupled to said lamp arm.

5. The multi-function tabletop stand of claim 4, wherein said light is pivotably connected to said lamp arm.

6. The multi-function tabletop stand of claim 4, wherein said lamp arm is pivotably connected to said stand base.

7. The multi-function tabletop stand of claim 1, wherein said charger is detachably coupled to said stand base.

8. The multi-function tabletop stand of claim 1, wherein:
said charger includes a charger base and a charger panel pivotably connected to said charger base to selectively position said charger panel at an angle with respect to said charger base; and
said charger panel is configured to support and charge a smartphone.

9. The multi-function tabletop stand of claim 8, wherein said charger base includes a charger recess configured to receive and charge wireless earphones.

10. The multi-function tabletop stand of claim 8, wherein:
said charger includes a charger shelf projecting from said charger panel above said charger base when said charger panel is positioned at an angle with respect to said charger base; and
said charger shelf is configured to support and charge a smart watch positioned thereon.

11. The multi-function tabletop stand of claim 1, wherein said speaker is detachably coupled to said stand base.

12. The multi-function tabletop stand of claim 11, wherein:
said speaker includes a rechargeable battery; and
said speaker is wirelessly connectable to an audio device.

13. The multi-function tabletop stand of claim 1, further comprising an additional speaker positioned in a respective one of said receptacles.

14. The multi-function tabletop stand of claim 1, wherein further comprising an electronic display configured to display words and images.

15. The multi-function tabletop stand of claim 1, wherein:
each of said receptacles configured to receive said charger and said speaker is shaped to partially surround and follow an outer surface of its respective one of said charger and said speaker;
each of said charger and said speaker is shaped such that exposed sections of an outer surface thereof are aligned with adjacent sections of an outer surface of said stand base to present a continuous surface appearance;
said illumination device is detachably coupled to said stand base;
said illumination device is a lamp;
said lamp includes a lamp arm extending vertically from said stand base;
said lamp includes a light coupled to said lamp arm;
said light is pivotably connected to said lamp arm;
said lamp arm is pivotably connected to said stand base;
said charger is detachably coupled to said stand base;
said charger includes a charger base and a charger panel pivotably connected to said charger base to selectively position said charger panel at an angle with respect to said charger base;
said charger panel is configured to support and charge a smartphone;
said charger base includes a charger recess configured to receive and charge wireless earphones;
said charger includes a charger shelf projecting from said charger panel above said charger base when said charger panel is positioned at an angle with respect to said charger base;
said charger shelf is configured to support and charge a smart watch positioned thereon;
said speaker is detachably coupled to said stand base;
said speaker includes a rechargeable battery; and
said speaker is wirelessly connectable to an audio device.

16. The multi-function tabletop stand of claim 15, further comprising an additional speaker positioned in a respective one of said receptacles, and further comprising an electronic display configured to display words and images, wherein said electronic display is positioned on said lamp arm.

17. The multi-function tabletop stand of claim 1, wherein:
said illumination device is a makeup mirror; and
said makeup mirror includes a mirror portion and at least one light mounted at a perimeter of said mirror portion.

18. The multi-function tabletop stand of claim 17, wherein:
each of said receptacles configured to receive said charger and said speaker is shaped to partially surround and follow an outer surface of its respective one of said charger and said speaker;
each of said charger and said speaker is shaped such that exposed sections of an outer surface thereof are aligned with adjacent sections of an outer surface of said stand base to present a continuous surface appearance;
said illumination device is detachably coupled to said stand base;
said charger is detachably coupled to said stand base;
said charger includes a charger base and a charger panel pivotably connected to said charger base to selectively position said charger panel at an angle with respect to said charger base;
said charger panel is configured to support and charge a smartphone;
said charger base includes a charger recess configured to receive and charge wireless earphones;
said charger includes a charger shelf projecting from said charger panel above said charger base when said charger panel is positioned at an angle with respect to said charger base;
said charger shelf is configured to support and charge a smart watch positioned thereon;
said speaker is detachably coupled to said stand base;
said speaker includes a rechargeable battery; and
said speaker is wirelessly connectable to an audio device.
